(19) United States
(12) Patent Application Publication
(10) Pub. No.: US 2014/0052504 A1
(43) Pub. Date: Feb. 20, 2014

(54) SYSTEM AND METHOD FOR MARKETING POLITICAL MEMBERSHIP

(71) Applicant: Jack Barron, Southborough, MA (US)

(72) Inventor: Jack Barron, Southborough, MA (US)

(21) Appl. No.: 13/587,363

(22) Filed: Aug. 16, 2012

(51) Int. Cl. G06Q 40/00; G07C 13/00

(52) U.S. Cl. 705/12; 705/329

(57) ABSTRACT

A method and system for providing a fundraising/voting service is described. In one example, the method includes receiving user information, a candidate selection and a pledge amount, storing, by a processor, the user information, the candidate selection and the pledge amount, and determining, by the processor, an election influence associated with the candidate selection and the pledge amount.

### BACKGROUND

In United States, a general election is an election held pursuant to a periodic schedule, in which a candidate, who receives the majority of votes, for a political office becomes the successor to that office. Elections may be local, state-wide, or national and may be governed by election laws or rules of the respective jurisdiction. Various cabinet positions related to the elected office may either be separately elected or appointed by the elected successor.

In turn, a primary election is an election held by a political party to nominate candidates for the general election. Presidential and state-wide primary elections are typically partisan, while local elections may be non-partisan. Primaries may be closed or open. In closed primaries, voters registered with the political party of the candidates running for office may vote for those candidates; while in open primaries, registered voters may vote in any party primary regardless of their own party affiliation. Other methods of selecting candidates include caucuses, conventions, and nomination meetings.

For primary elections, the political parties typically employ a system of pledged and unpledged or super delegates. The pledged delegates are either elected or chosen with the presumption that the delegate selects a particular candidate at the political party convention. The pledged delegates are distributed among the states, with each state holding a state primary election. The winner of the state primary receives a percentage of the pledged delegates. A candidate typically needs to win a simple majority of total delegates to earn a nomination at the national convention.

### SUMMARY

It is appreciated that fundraising is an essential element of a successful campaign for political office, either a primary or a general election. In fact, in some cases the amount of money raised by each candidate may be dispositive of the outcome of the election. Funding sources may include private donors, national political parties, political action committees (PAC) or self-funding. Generally, the larger the contribution amount, the more influence the source or the donor may have on the candidate. One way to decrease the influence of large donors is to fundraise from a larger pool of smaller donors. However, small contributors may feel that they have too small of an impact and therefore may be less likely to donate to a candidate or a political party. Some small contributors may be more inclined to pledge to a candidate if they feel that the donation has a direct impact on the election results, for example, if the donation goes to directly support the candidate.

Therefore, methods and systems described herein provide for voters to donate a relatively small amount that may have an influence on an election. In some embodiments, the methods and systems may be used as a fundraising tool, without being tied to an actual vote or election results. In other embodiments, the methods and systems described provide a virtual voting system. The virtual voting system allows for fundraising for a political candidate or a political party, and may further simulate an actual vote or election results. In aspects and embodiments described, the system includes a user interface that allows a voter to pledge and vote on one or more elections. In some embodiments, the user interface may provide a visual indication of the impact to their donation, for example by indicating an influence percentage on a particular election.

The system and method further includes a political party interface for a political party to set up elections with various pledge and vote settings and rules, and to receive voter donations. For political parities and candidates, the system provides access to a large number of small donations and direct access to fundraising money. Receiving a larger amount of funding from a wider percentage of voters diminishes the influence of individual larger donors.

According to one embodiment, a method for providing a fundraising service comprises receiving user information, receiving a candidate selection, receiving a pledge amount, storing, by a processor, the user information, the candidate selection and the pledge amount, determining, by the processor, an election influence associated with the candidate selection and the pledge amount, transmitting the election influence to a user, and transmitting the pledge amount and the user information to a computer system related to a political party.

In one example, the method further comprises receiving a political party selection, storing, by the processor, the political party selection, and determining, by the processor, the election influence based on the political party selection, the candidate selection and the pledge amount. In addition, the method may further comprise determining at least one candidate selection based on the political party selection. In one example, the user information comprises at least one of: a name, an address, a phone number, social security information and an email address.

In another example, the method further comprises determining the election influence by determining a weighted vote associated with an election and based on the pledge amount and the candidate selection. In yet another example, the method further comprises determining the election influence by comparing the pledge amount to statistical election fundraising information.

In one example, the method further comprises receiving a geographic selection and transmitting at least one election for political office to the user associated with the geographic selection. In addition, the method may further comprise receiving a vote associated with the candidate selection.

In another example, the method further comprises aggregating information including at least one of: the user information, the candidate selection and the pledge amount and transmitting statistical information to the political party interface based on the aggregated information.

In another embodiment, a system for providing a fundraising service comprises an interface configured to receive user information, a candidate selection and a pledge amount, a memory configured to store the user information, the candidate selection and the pledge amount, a processor configured to determine an election influence associated with the candidate selection and the pledge amount, wherein the interface is configured to transmit the election influence, the pledge amount and the user information.

In one example, the interface may be configured to transmit, the pledge amount and the user information to a computer system associated with a political party and the interface is further configured to transmit the election influence to a user. In addition, the interface may be configured to receive a political party selection, the memory may be configured to store the political party selection and the processor may be configured to determine the election influence based on the political party selection, the candidate selection and the pledge amount. In another example, the user information comprises at least one of a name, an address, a phone number, social security information and an email address.

In one example, the processor is configured to determine a weighted vote amount associated with the pledge amount and the candidate selection. In another example, the processor is configured to determine the election influence by comparing the pledge amount to statistical fundraising information associated with an election result. In yet another example, the interface is configured to receive a geographic selection from the user interface, the processor is configured to determine at least one election for political office associated with the geographic information selection.

In another example, the processor is configured to aggregate information based on at least one of: the user information, the candidate selection and the pledge amount and the interface is configured to transmit statistical information based on the aggregated information to a computer system associated with a political party. In addition, the interface may be configured to receive a vote associated with the candidate selection.

According to another embodiment, a non-transitory computer readable medium for providing a fundraising service, having stored thereon sequences of instruction that are capable of causing at least one processor to receive user information, receive a candidate selection, receive a pledge amount, store the user information, the candidate selection and the pledge amount, determine an election influence associated with the candidate selection and the pledge amount, transmit the election influence to a user, and transmit the pledge amount and the user information to a computer system related to a political party.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example. References to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the invention. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a diagram of a distributed system fundraising and voting for voters and members of a political party, according to one embodiment;

FIG. 1A is a diagram of a user interface, according to one embodiment;

FIG. 1B is a diagram of a pledge screen included in the user interface, according to one embodiment;

FIG. 2A is a flow diagram of a method of providing fundraising/voting service, according to one embodiment;

FIG. 2B is a flow diagram of another method of providing fundraising/voting service, according to one embodiment; and

FIG. 3 is a block diagram of one example of a computer system that may be used to perform processes and functions disclosed herein.

### DETAILED DESCRIPTION

As described above, the political party interface provides a fund raising tool for a political party or a candidate. In the embodiments described below, the user interface provides a way for a voter to take part in an election in exchange for a pledge or a donation. In some embodiments, the user interface provides for a user to influence an election, no matter how minimal that influence may be. In these embodiments, the user provides a pledge amount, selects a candidate and may then participate in an election by voting in online voting system. The political party or the candidate may then give the vote a particular status toward electing or selecting a candidate. For example, in a primary, in exchange for the received vote, the political party may pledge party delegates (or a percentage of a party delegate) at the party convention. The vote may be a real vote for a candidate and may be counted or considered by an election official. Alternatively, the vote may be an intent to vote for a candidate and may not be counted or considered by an election official.

In other embodiments, the methods and systems described may provide a virtual voting system. The virtual voting system allows for fundraising for a political candidate or a political party, and may further simulate voting based on actual elections. In these embodiments, the user provides a pledge amount, selects a candidate and/or a political party and may then submit a vote in an election. The political party may receive the vote and the pledge amount. Unlike the system and method described above, the vote received may not guarantee a particular status toward electing a candidate. However, the virtual voting system may allow for the user to vote in elections closed to the voters in the real world. For example, using the virtual voting system the user registered with one political party may cast a vote for a candidate in a closed primary associated with another political party. In another example, the user may vote for candidates not presented on an actual election ballot. The virtual voting system may also be used by a candidate or political party to gauge interest in or support for a candidate based on virtual voting.

In further embodiments, the voter and political party interfaces may be used as a fundraising tool without being tied to a physical vote or election results. For example, the user interface may be used for fundraising for different candidates or parties based on information a user provides relating to an interest in a candidate or a political party. In other examples, the user reviewing information regarding a candidate or political party on a website may be directed to the user interface to provide a donation to the candidate or political party. In other examples, the user may be directed to the user interface based on an affiliation with different organizations. In some examples, the funds received from the user via the user interface may be directed by a political party to the candidate selected by the user via the interface.

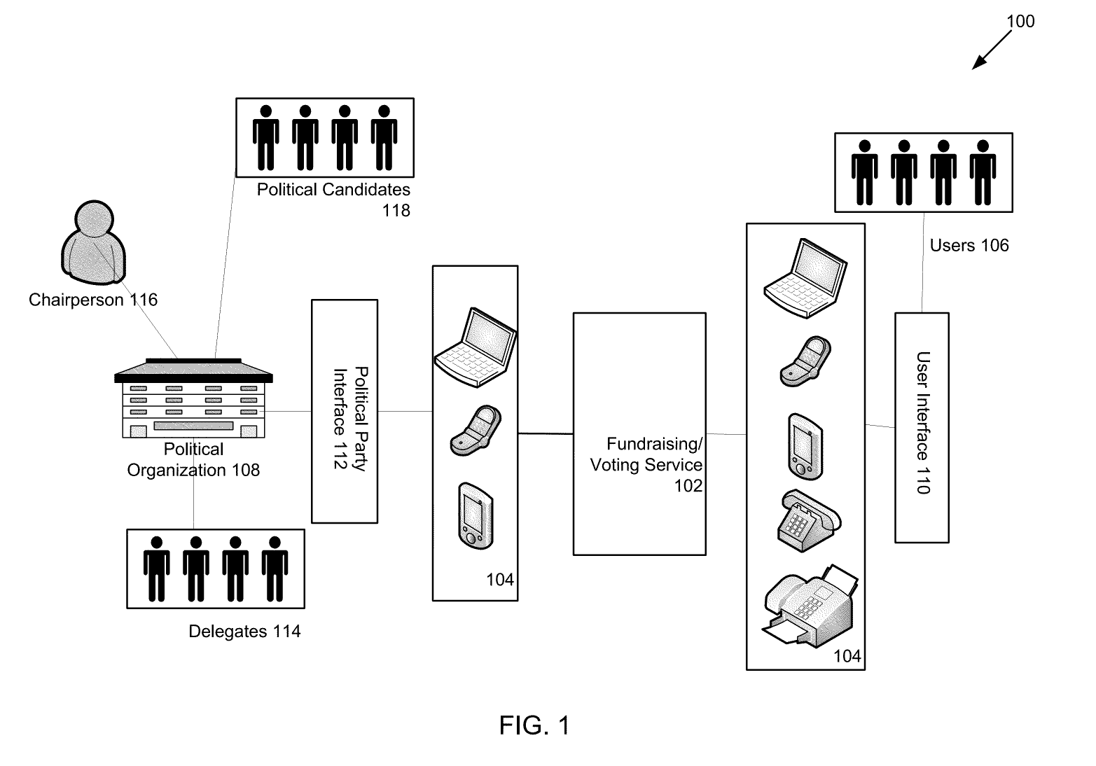

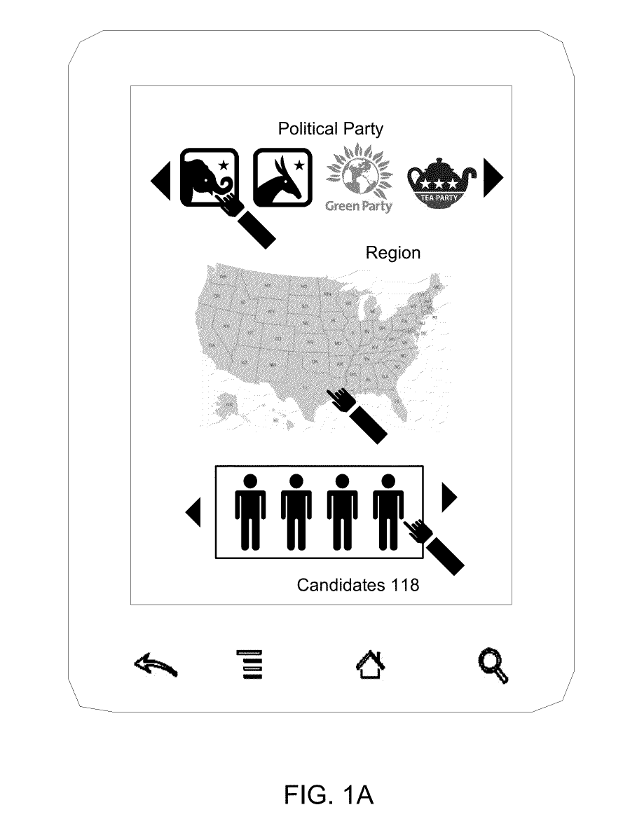

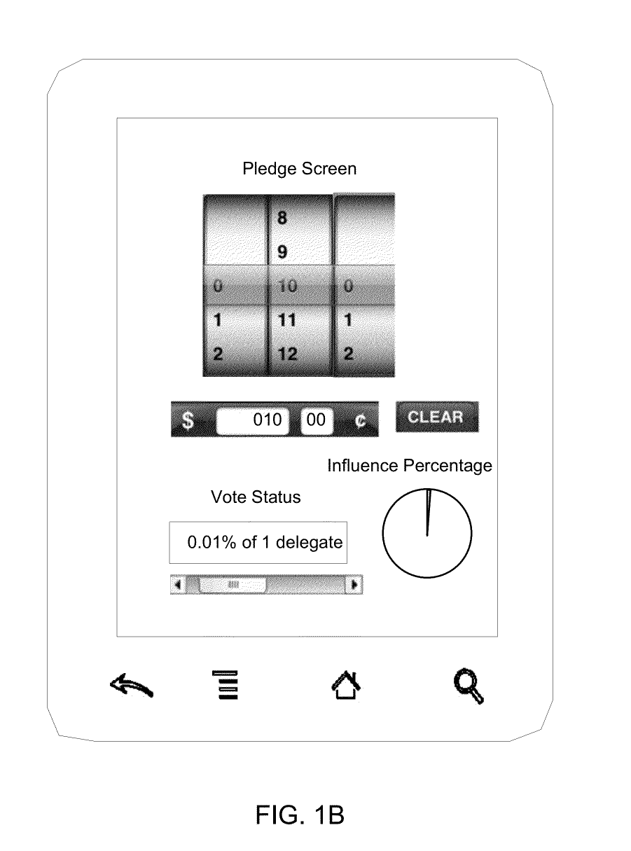

FIG. 1 shows a distributed fundraising system 100 including a voting and fundraising service 102 for managing and enabling communication of voting and fundraising information between voters 106 and political parties 108. The distributed system may include devices 104, a user interface 110 for users 106, and a political party interface 112 for the political party 108, each described in more detail below. The political party 108 may include various members including delegates 114, a chair person 116 and political candidates 118. In various examples described herein, the fundraising/voting service 102 allows one or more users to vote for a political candidate in exchange for a pledge amount. In some embodiments, the votes may be tied to a vote that is recognized by a political party or a candidate. In other embodiments, the votes may be virtual votes not tied to any candidate selection. In turn, the fundraising service 102 allows political parties 108 or candidates 118 to obtain funds to fund campaigns. In addition, the user interface 110 may provide information about various candidates and political parties, while the political party interface 112 provides for the political party organization members to track fundraising and receive statistic information about the users.

The fundraising/voting service 102 is connected to the devices 104 via the interfaces 112 and 110. Users , political party members, and candidates may each access the fundraising/voting service 102 via the respective interfaces on the devices 104. The devices 104 shown are for purposes of illustration only and any electronic communication device may be used to access the fundraising/voting service 102.

According to various examples, one or more components of the distributed fundraising system 100 may be implemented using one or more computer systems, such as the distributed computer system 400 discussed below with regard to FIG. 4. Thus, examples of the distributed fundraising system 100 include a variety of hardware and software components configured to perform the functions described herein and examples are not limited to a particular hardware component, software component or a particular combination thereof. The fundraising/voting service 102 may be implemented as a cloud-based computing platform, such as the EC2 platform, available from Amazon.com, Seattle, Wash. However, it should be appreciated that other platforms and cloud-based computing services may be used.

User Interface

The user 106 may register and use the fundraising/voting service 102 via the user interface 110 on one of the devices 104. The registration process may include the user interface 110 prompting the user for information including address, citizenship, age, political party affiliation, and/or payment information. The information collected by the user interface 110 may be used to provide services for the user and to verify legal voting status. In various examples, to access the interface the user may provide one or more inputs to one of the devices 104, such as a cell phone, a feature phone, a smart phone, a PDA, a tablet computer, laptop computer, a desktop computer, a landline phone, a fax machine or any other communication device. The user may also register one or more of these devices 104 through which the user may provide votes and access information.

In some embodiments, based on the provided information via the user interface 110, the fundraising/voting service 102 may verify that the users are registered and can legally vote. For example, the voting interface 110 may prompt the user to provide name and address information during voter registration, which the fundraising/voting service 102 may verify against voter registration records. In one example, the fundraising/voting service 102 may perform the verification by searching voter registration records for potential matches. If the user is not registered to vote, the voting interface 110 may direct the user to government websites with instructions for voter registration.

In other examples, the fundraising/voting service 102 may allow unregistered voters or those not legally able to vote to make a contribution and be able to vote in the party elections. In these examples, the voter verification process may be skipped, allowing the user to register with the fundraising/voting service 102 without verification of voting registration. The voter verification preferences may be set by members of the political party organization when using the fundraising/voting service 102. For example, in some elections the political party organization may only want registered and verified voters, but in other elections the party may allow anyone to vote.

One example of the voting interface 110 is illustrated in FIG. 1A. The voting interface 110 may prompt the user to select a political party, a geographic region and a candidate. Any political party may be displayed via the user interface 110, for example, republican, tea party, democrat, green party, as well as any other party . The user may be presented with information about the selected party. For example, the user interface 110 may display to the user information about the party's position on various political issues, information on members of the party, as well as local or national demographic information.

In various examples, the fundraising/voting service 102 may limit the user's selection of a political party based on the information provided by the voter at the registration stage. The limitation may be based on local election rules and/or political party set preferences. For example, users may be previously registered or unregistered with a political party. The political party or local election rules may determine whether votes from members of another party can be accepted, such as in a closed or open primary. For example, local rules may provide for open primaries, however, a political party may set preferences for the vote to be closed. Therefore, in setting up an election via the fundraising/voting service 102, the political party organization may decide whether unregistered or opposing side members may vote in a given election.

The user selects a party and the user interface 110 may display a list of elections for the user to select one of the elections to cast a vote. The list of elections may include any political races where members of the party are running for any type of office and where the fundraising/voting service 102 determines the user may vote based on local rules and election preferences set by the political party. In some examples, the listed elections are representative of actual, real-life elections run by political parties, federal, state or local governments, where a vote for a candidate may be tied to the election outcome.

In other examples, the listed elections may be virtual elections, where a vote for a candidate may not be tied to the election outcome. Virtual elections may be created by candidates, political parties or others where the fundraising/voting service 102 determines that the user can vote based on preferences set by the creator of the election. In some examples, the virtual elections may be representative of actual or ongoing elections. In these examples, the preferences of the election, such as geographic area, party limitations, beginning and ending times, and number of votes submitted, may be modeled after actual election rules. In other examples, the virtual elections may not be associated with actual or ongoing elections and the preferences may include any desirable preferences set by the creator. As described above, in these virtual elections, the user registered with one political party may cast a vote for a candidate in a closed primary associated with another political party or for a candidate not appearing on an actual ballot.

In at least one example, the user interface 110 may prompt the user to search for elections in a particular geographic region (e.g. a state). The elections may be national such as presidential elections, senatorial elections, congressional elections, or local elections such as gubernatorial, mayoral, local senate or congress, or may include other types of elections. Some elections that are representative of actual elections may be limited by user residence either by local rules or by political party preferences while other elections may be open to accept votes from any user. In one example shown in FIG. 1A, the user may vote in a presidential primary for the Republican Party in the state of Texas where the user is registered as a voter. As described above, virtual elections may or may not be geographically limited based on options set by the creator of the virtual elections.

The user interface 110 may displays a list of candidates 118 running for office in the selected election. For example, in a primary election any number of candidates presently in a political race may be included. In other examples, the user may be presented with other potential selections or voting options. For example, potential cabinet position appointees, appointments for agencies, judicial appointees, or any other individuals may be presented to a user for selection via the interface. In other embodiments, the user interface 110 may bypass the political party selection options and the election selection options and directly display a list of candidates running for office. These candidates may be running for office in specific elections, currently holding a political office, unrelated to either an ongoing election or political office, and may or may not be associated with a political party.

The political party information, the list of available elections, and/or the list of candidates may be transmitted from the fundraising/voting service 102 to the user interface 110 on demand and may be updated periodically. Alternatively, this information may be transmitted to the user interface 110 in real-time as the information is requested by the user.

In the embodiments where the user interface 110 is used for actual or virtual elections, the user may vote for the desired candidate via the user interface 110 from the list of candidates. In actual election embodiments, the vote may be a real vote for a candidate and may be counted or considered by an election official. Alternatively, the vote may be an intent to vote for a candidate and may not be counted or considered by an election official. In other embodiments where the user interface 110 is used for fundraising purposes, the user interface 110 may direct the users directly to a pledge screen, bypassing the candidate selection and/or voting screens. In some embodiments, the pledge or donation received from the user is unconnected to an actual vote.

The user interface 110 may display a pledge screen to the user. The user may select an amount of money to pledge to the candidate via the user interface 110. For example, the user interface 110 may display a scroll menu with different amounts of money. Alternatively, the user may manually type in a pledge amount. In some embodiments, the user may enter a pledge amount and view the associated vote status and total influence, as described below. Once the amount is entered the user may be directed to a payment screen where the user enters payment information, such as credit card or bank account information. The user may also select other methods of payment, such as bill me later. The user may be presented with a confirmation and receipt screen.

According to various embodiments, the pledge amount may or may not be tied to an actual or virtual vote. As described below, in embodiments where the pledge is associated with actual elections, the pledge amount and the vote received may be given a particular status, which may influence the selection of the candidate in the actual election. In other embodiments, the vote received in virtual elections may be associated with a pledge amount but may not be given a particular status. In further embodiments, where the user interface is used exclusively for fundraising, only the pledge amount may be received without the need for a vote. In addition, the pledge amount may be independent of the vote.

In embodiments of the user interface 110 used for actual or virtual elections, the pledge amount and the vote may be transmitted to the fundraising/voting service 102. In embodiments where the pledge amount is independent of any actual or virtual vote, the pledge amount may be transmitted to the fundraising/voting service 102 without a vote. The vote and/or the pledge amount information may be transmitted from the user interface 110 to the fundraising/voting service 102 on demand and may be updated periodically. Alternatively, the vote and/or pledge amount information may be transmitted to the fundraising/voting service 102 in real-time as the information is entered by the user in the user interface 110.

According to examples of the user interface 110 associated with an actual vote, the user interface 110 or the fundraising/voting service 102 may determine the particular vote status and a total influence percentage. In various examples, the vote status describes a relationship between an amount of money pledged for a particular candidate, party or election and the type and amount of weight given to a vote. For example, in a primary election, a vote may be given a particular status to guarantee a pledged delegate to a candidate at a political party convention.

The total influence percentage may be determined as the overall weight given to the vote to elect a candidate. In the primary election example, the total influence percentage may correspond to the vote's effect on the total number of delegates needed to secure a party nomination. According to one example, the vote status may be preset by the political party or the candidate via the political interface 112 and the total influence percentage may be determined by the fundraising/voting service 102.

The total influence percentage may also be calculated based on historical fundraising and voting patterns. It is appreciated that there may be a relationship between an amount of money raised by a candidate and a winning result in an election. Therefore, the total influence percentage may relate a received pledge amount to a percentage out of the total amount raised associated with wining an election. For example, for a United States senate race for a particular state, the average amount raised by a winning candidate may be 8 million dollars. In one example, the total influence percentage may be a relationship between the pledge of 10 dollars and the total raised amount of the 8 million needed.

In other examples, the total influence percentage may be determined by the user interface 110. The vote status and the determined influence percentage may be displayed to the user via the user interface 110. One example of a pledge screen and the associated vote status and total influence percentage is shown in FIG. 1B. The total influence percentage and the vote status may be displayed to the user via the user interface 110. The relationship between the pledge amount and the vote status may be set in discrete intervals or may be continuous.

One example of the vote status and total influence percentage in a presidential primary election is described with reference to FIG. 1B. In this example, the user selects a pledge amount of ten dollars. In one example of a primary election, this pledge amount corresponds to a vote status described as 1/100 of a percent of a pledged delegate in a first ballot election. That means that 0.01% of a pledged delegate in a primary election is guaranteed for the voted for candidate. The determined influence percentage may be determined by the user interface 110 based on information received from the fundraising/voting service 102 for the selected primary election. In this example, the influence percentage may be determined using the total number of delegates needed to secure a nomination. For example, in 2012 the total number of delegates required to secure a republican nomination was 1,144. In 2012, the influence percentage associated with 0.01% of one delegate purchased using the fundraising/voting service 102 corresponds to 0.0009%. Accordingly, in this example if the user submits a pledge of 100 dollars, 1% of a delegate in primary election may be guaranteed for the selected candidate and the corresponding influence percentage corresponds to 0.09%.

It is appreciated that the invention is not limited to particular pledge amounts, or corresponding vote status, and any other pledge amounts and vote status may be used. For example, for a cabinet position (such as secretary of state) in a presidential election, a pledge amount of 10 dollars may be associated with 0.0001% vote status for a potential appointee to the candidate position. That means the candidate who is elected to office has to weigh the decision to select the potential appointee for that cabinet position with particular vote status. In this example, the vote status and the influence percentage may be equal.

As shown in FIG. 1B, the user interface may display the relationship between the pledge amount and the vote status and influence percentage graphically. For example, the pledge to influence relationship may be displayed as a scroll bar that corresponds to the pledge amount and an influence bar graph that corresponds to the influence amount. As a result of user dragging the scroll bar, the influence bar graph may increase or decrease.

Other Interfaces

It is appreciated that the pledge amount and/or vote may be submitted using other devices 104. For example, the user may submit a pledge using a telephone, fax or via SMS messages using various corresponding interfaces. In one example of submitting a pledge via a telephone, the user interface includes an automated telephonic system. Using the automated telephonic system the user may be sequentially prompted through the registration steps, the candidate selection steps and the pledge steps, described above. For example, the user, through voice or keypad prompts, may both register as a user of the fundraising/voting service and be verified as a registered voter. In addition, the telephonic system may play prerecorded information to the user, for example information regarding the political party, the available elections and candidate information. Through a series of audio prompts the user may enter the political party, candidate information and payment information. For example, the telephonic system may include an interactive voice response technology, which may allow users to interact with the fundraising and voting system via a telephone keypad or by speech recognition. Interactive voice response may respond with prerecorded or dynamically generated audio to further direct users on how to proceed within the fundraising and voting system. The user may also submit pledges using text or fax. However, the user may need to be registered and verified by the system prior to submission of the pledge and the vote.

Fundraising/Voting Service

Referring again to FIG. 1, the fundraising/voting service 102 may be configured to communicate with users, political parties, and candidates by sending and receiving information via various devices and interfaces. The communication with users may be transmitted and displayed via user interfaces 110 and devices. The communication with the political parties and candidates may be transmitted and displayed via the political interfaces 112.

According to various examples, the fundraising/voting service 102 sends, receives and stores user information such as voter verification information, user login and password information, user payment information, historical voting records, and any analytical information derived from the user information, as well as political party member user information, candidate information, pledged and unpledged delegate information. In addition, the fundraising/voting service 102 sends, receives and stores information pertaining to pending or ongoing elections such as vote status, current total pledge amount, number of votes received, sources of votes and pledges received, as well as, preferences set or rules for the ongoing elections.

Other user information may be preloaded and stored in the fundraising/voting service 102 for the purposes of carrying out embodiments of the service described herein. This information may be retrieved by the users or political party members of the service on demand. For example, the fundraising/voting service 102 may store information from voting records, which may be used to compare and verify users, political party information, election rules or other information, information pertaining to candidates and any other information related to registered voters and political parties.

The service 102 may be configured to aggregate and analyze various information received from multiple sources and may present the aggregated information to on to various users via the interfaces described herein. For example, the service may analyze and display user aggregated information, such as user demographics, and pledge information as it relates to different candidates and political parties.

According to various examples, the service 102 may be preset with various preferences for each election as described above, such as the type of election (virtual or actual), and the political party membership. Other preferences may be set by the political party, such as maximum and minimum pledge amount and maximum number of voting times per user. The pledges and user information transmitted from devices 104 via the user interface 110 may be compared against the preferences stored in the service 102 to determine whether the user is within the limits of the preferences. Setting of the maximum limits preferences may provide a check against a single user influencing the vote.

Political Party Interface

According to various examples, the political party interface 112 is provided for members of the political party organization and for political candidates. The political party interface 112 allows either the candidates or political party members to create new elections, as well as access and manage previously created elections.

In some examples, the user may register and log in to the political party interface 112. In the registration process, the user may be prompted to enter the position title within the political party 108, for example, candidate 118, chairperson 116, vice-chairman, or other positions within the organization. In some examples, based on various pre-set rules, the fundraising/voting service may determine the appropriate level of authority based on inputs provided by the political party and rules pre-set for the service 102. For example, the chairperson 116 may have authority to set national elections, while regional members of the organization may have authority to set preferences for local elections within their designated region.

A registered user of the political party interface 112, with appropriate access, may create new elections and set the election preferences described above. For example, a regional member of the Republican Party may create a state senate race including Republican primary election. As described above, users via the political party interface 112 may create and set preferences for an election, such as actual or virtual, open or closed, and the vote status in the election based on a pre-set pledge amount. The political party interface 112 may also allow the user to pre-set beginning and ending dates of the election, voter verification options, maximum and minimum pledge amounts, the number of times a user may vote in an election and the number of candidate the user may select, as well as other preference available for the user. It is appreciated that the preferences may be limited by local or national election rules (such as the type of election, or the closing date of the election).

The registered user of the political party interface 112, with appropriate access, may manage and view previously created elections, described above. The political party member may use the political party interface 112 to track the pledge amounts and votes received for ongoing elections and to transfer funds pledged to the political party. This information may be transmitted from the fundraising/voting service 102 to the political party interface 112 on demand and may be updated periodically. Alternatively, this information may be transmitted to the political party interface 112 in real-time.

In addition, users, via the political party interface 112, may be able to view aggregated information regarding users and voting patters as described above. For example, the political interface 112 may provide demographic information about users voting in an election and voting patterns may include information regarding geographic location of the user. The user of the political party interface 112, with appropriate authority, may set up preferences for transferring funds from the fundraising/voting service 102 to the political party.

In addition, various other users may be allowed to access to the political party interface 112. For example, candidates running for office may set up individual accounts via the political party interface 112. Using the political party interface 112, the candidates may be able to track voting patterns in any elections created with the fundraising/voting service, such as the number of votes/pledges received for the particular candidate as well other candidates in any given election. The candidate may also be able to search historical election information. The candidate may use the political party interface to track the pledge amounts and to transfer funds pledged to the candidate.

In addition, in embodiments associated with actual elections, prior to distributing funds from an election, the political party interface 112 may prompt a political party member or candidate to verify or confirm that the given election result was weighed according to the vote status set by the political party or candidate,. For example, if the vote status for each candidate is set to be 0.01% of a pledged delegate, the interface may prompt the political party member to enter the number of delegates influenced by the fundraising/voting service (e.g. 2.5 delegates for candidate X) in a first ballot election at the national party convention. The number of influenced delegates may be compared with the total number of votes received for that candidate via the user interface (e.g. 250 votes) to verify that the influence percentage is accurate.

Example Methods

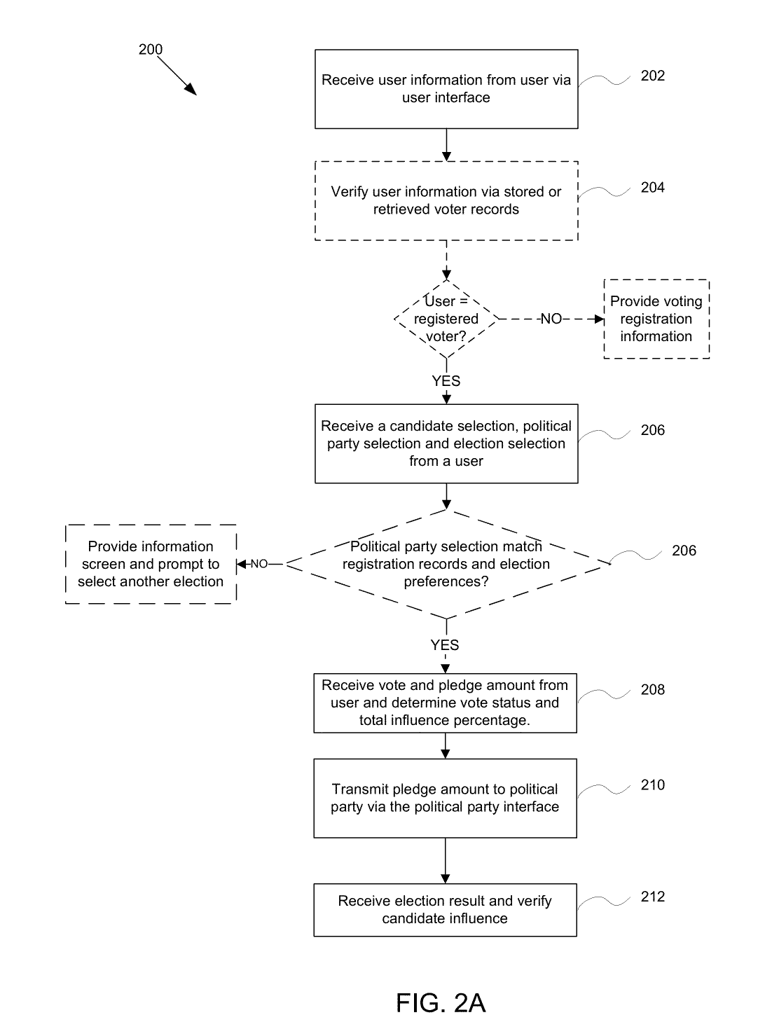

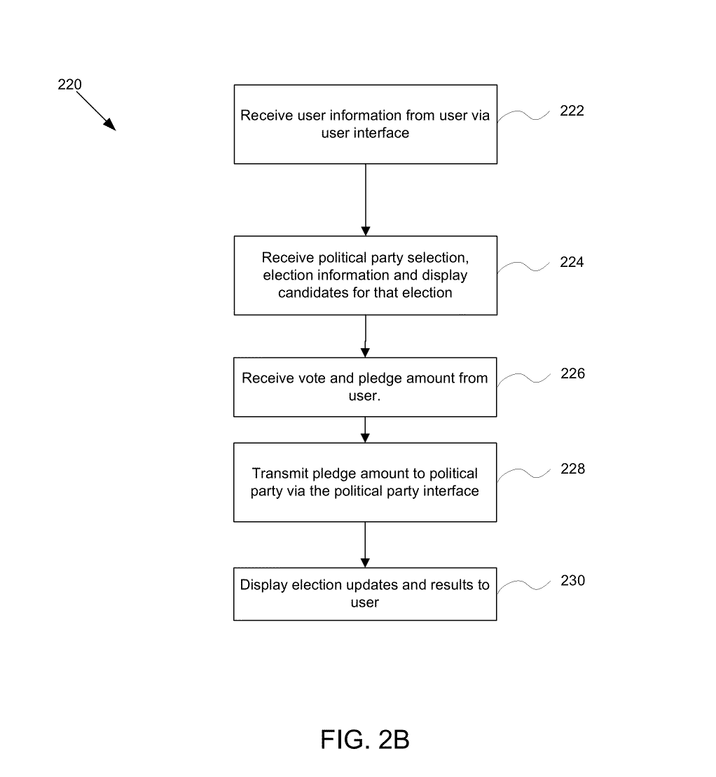

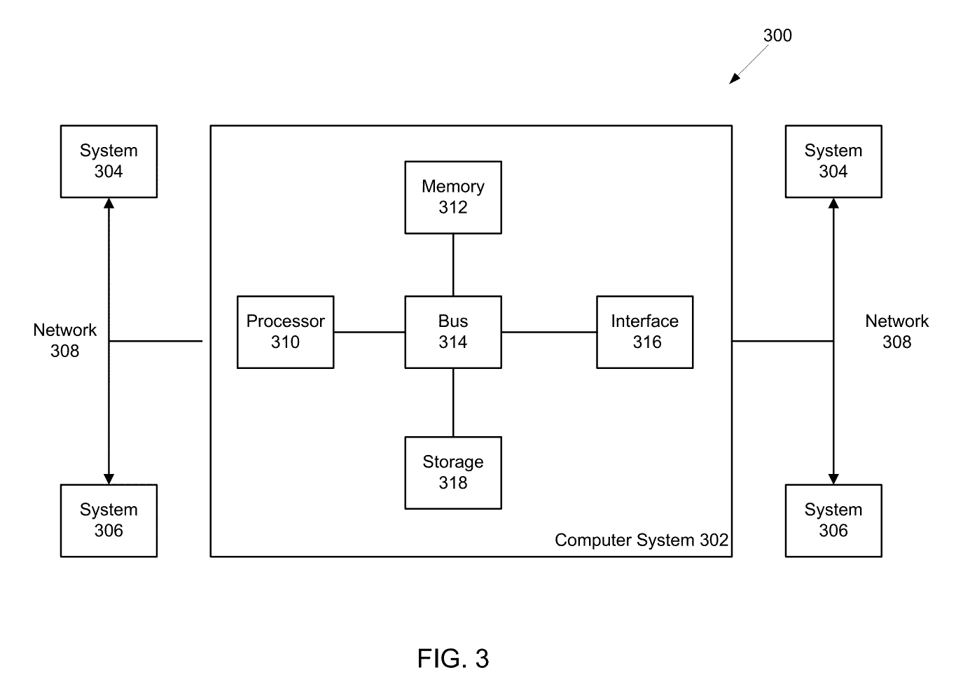

FIGS. 2A and 2B illustrate methods 200 and 220 of performing fundraising and voting for example by using the devices 104 and interfaces 110, 112 and distributed system 100 described above with reference to FIG. 1 and the computer systems described below with reference to FIG. 3. The method 200 may be associated with actual elections, where the received vote and the pledge amount are granted a particular status and weigh an election result. While method 220 may be associated with virtual elections and fundraising for a particular candidate. In an actual election, the vote may be a real vote for a candidate and may be counted or considered by an election official. Alternatively, the vote may be an intent to vote for a candidate and may not be counted or considered by an election official.

In step 202, the fundraising/voting service receives user information input by the user via the user interface 110. As described above, user information may include for example, name, address, and date of birth.

In step 204, the user information is verified by comparing the user information with voting records to determine if a match can be found. In one example, if no match is found the user is directed to information regarding voting registration and the user may not use the service until the user is verified to be a valid voter. For example, this information may be location on a state or a national voting registration website. In other examples, the user may be able to use the service without verifying valid voter information.

In step 206, the user inputs a political party selection and an election selection input by the user via the user interface 110. Based on the political party selection and election preferences, elections in which the user can participate are determined. In one example, the political party selection may be verified by comparing the selection with voting records to determine if a match can be found (step 208). The political party selection may also be compared with preferences set by the political party and election rules (e.g. open or closed primaries). This comparison may be optional and in other examples, the political party selection may be received without verification. Based on the political party selection and the election selection, the user is provided with a list of candidates for which the user can vote. The candidates may be displayed to the user via the user interface 110.

In step 210, the user inputs a vote for one of the candidates displayed and enters a pledge amount via the user interface 110. Based on the pledged amount and the preset preferences the vote status is displayed to the user via the user interface 110. In addition, the total influence percentage is determined and displayed to the user via the user interface 110. The vote and the pledge amount information may be transmitted to the fundraising/voting service 102, which may store this information.

In step 212, the vote and the pledge amount information is transmitted to the political party via the political party interface 112. The given election result may then be weighed based on the vote status associated with the received votes and the total number of votes received from all the users participating in the given election. For example, in the primary election example described above, each vote is given a vote status of 1/100 of a delegate in a first ballot election at the party convention. If 100 votes are received for candidate A, 200 votes are received for candidate B, and 300 votes are received for candidate C, at the first ballot primary election, candidate A receives one pledged delegate, candidate B receives two pledged delegates and candidate C receives three pledged delegates.

In step 214, at the conclusion of the election the fundraising/voting service 102 may verify that the election was conducted in accordance with the method 200. In one example, the verification may be completed by requesting and receiving an election result confirmation from the political party or the candidate. In response to the verification, funds may then be distributed to the political party or candidate. For example, in the primary election example described above, the fundraising/voting service 102 may prompt the political party member to enter the election result confirmation in the form of the number of delegates each candidate received via the general primary election and the number guaranteed based on the votes via the fundraising/voting service 102.

In some embodiments, an alternative method 220 of voting and/or fundraising is illustrated in FIG. 2B. The method 220 may be implemented in virtual elections, where the vote and the pledge amount are received but do not have an effect on the election result. In other embodiments, method 220 may be implemented exclusively for fundraising. In one embodiment of the method 220, in step 222, the fundraising/voting service receives user information input by the user via the user interface 110.

In step 224, in one embodiment, the user inputs a political party selection via the user interface 110. Based on the political party selection and election preferences, elections in which the user can participate are determined. The user provides inputs an election selection and the user interface 110 displays candidates associated with the election selection. In other embodiments, in step 224, the user inputs only a political party selection and candidates associated with the selection political party are provided to the user.

In step 226, in one embodiment, the user interface 110 receives a vote and a pledge amount from the user. The vote and the pledge amount information may be transmitted to the fundraising/voting service 102, which may process and store this information. In another embodiment, in step 226, the user interface 110 receives only the pledge amount.

In step 228, the fundraising/voting service 102 transmits the pledge amount and/or vote to the political party interface 112, which receives the pledge amount and/or the vote. The political party interface 112 may receive each pledge amount and/or vote information as they are received by the fundraising/voting service 102. Alternatively, the political party interface 112 may receives aggregated information from the fundraising/voting service 102.

In step 230, the voting interface 110 may provide election updates and results to the user. For example, the voting interface 110 may display running election totals as they are updated based on the total number of votes received. In other embodiments, only the results of a given election may be displayed to the user.

Computer System

As discussed above with regard to FIG. 1, various aspects and functions may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

Various aspects and functions of the interfaces and services including the voting interface and the political party interface described above may be implemented using an iOS mobile platform and Software Development Kit (SDK), available from Apple, Inc, Cupertino, Calif. However, it should be appreciated that the following description is for example purposes and other mobile platforms along with other SDKs may be used to implement the interfaces and services described.

As described above with reference to FIG. 1 aspects and functions of the fundraising/voting service may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions may be practiced. The distributed computer system 300 may include one more computer systems that exchange (i.e. send or receive) information. For example, as illustrated, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

FIG. 3 illustrates a particular example of a distributed computer system 300 that includes computer system 302, 304 and 306. As illustrated in FIG. 3, the computer system 302 includes a processor 310, a memory 312, a bus 314, an interface 316 and data storage 318. The processor 310 may perform a series of instructions that result in manipulated data. The processor 310 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. The processor 310 is connected to other system components, including one or more memory devices 312, by the bus 314.

The memory 312 may be used for storing programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device. Various examples may organize the memory 312 into particularized and, in some cases, unique structures to perform the functions disclosed herein and these data structures may be tailored to store values for particular types of data.

Components of the computer system 302 may be coupled by an interconnection element such as the bus 314. The bus 314 may include one or more physical busses, for example, busses between components that are integrated within a same machine, but may include any communication coupling between system elements including specialized or standard computing bus technologies such as IDE, SCSI, PCI and InfiniBand. Thus, the bus 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and communicate with external entities, such as users and other systems.

The data storage 318 may include a computer readable and writeable nonvolatile (non-transitory) data storage medium in which instructions are stored that define a program or other object that may be executed by the processor 310. The data storage 318 also may include information that is recorded, on or in, the medium, and this information may be processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller may cause data to be read from the nonvolatile recording medium into another memory, such as the memory 312, that allows for faster access to the information by the processor 310 than does the storage medium included in the data storage 318. The memory may be located in the data storage 318 or in the memory 312, however, the processor 310 may manipulate the data within the memory 312, and then copy the data to the storage medium associated with the data storage 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (ASIC) tailored to perform a particular operation disclosed herein. While another example may perform the same function using a grid of several general-purpose computing devices running MAC OS System X with 64-bit Intel processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 3000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A method for providing a fundraising service, the method comprising:
receiving user information;
receiving a candidate selection;
receiving a pledge amount;
storing, by a processor, the user information, the candidate selection and the pledge amount; and
determining, by the processor, an election influence associated with the candidate selection and the pledge amount.

2. The method of claim 1, further comprising:
transmitting an indication of the election influence to a user; and
transmitting the pledge amount and the user information to a computer system related to a political party.

3. The method of claim 1, further comprising:
receiving and storing a political party selection; and
determining, by the processor, the election influence based on the political party selection, the candidate selection and the pledge amount.

4. The method of claim 2, further comprising determining at least one candidate selection based on the political party selection.

5. The method of claim 1, wherein the user information comprises at least one of: a name, an address, a phone number, social security information and an email address.

6. The method of claim 1, further comprising determining the election influence by determining a weighted vote amount associated with an election and based on the pledge amount and the candidate selection.

7. The method of claim 1, further comprising determining the election influence by comparing the pledge amount to statistical fundraising information associated with an election result.

8. The method of claim 1, further comprising:
receiving a plurality of pledge amounts; and
determining the election influence by comparing the pledge amount to at least one of the plurality of pledge amounts.

9. The method of claim 1, further comprising:
transmitting at least one election for political office to a user; and
receiving a vote associated with t the at least one election.

10. The method of claim 1, further comprising aggregating information including at least one of: the user information, the candidate selection and the pledge amount and transmitting statistical information to the political party interface based on the aggregated information.

11. A system for providing a fundraising service, the system comprising:
an interface configured to receive user information, a candidate selection and a pledge amount;
a memory configured to store the user information, the candidate selection and the pledge amount;
a processor configured to determine an election influence associated with the candidate selection and the pledge amount.

12. The system of claim 11, wherein the interface is configured to transmit, the pledge amount and the user information to a computer system associated with a political party and the interface is further configured to transmit an indication of the election influence to a user.

13. The system of claim 11, wherein the interface is configured to receive a political party selection, the memory is configured to store the political party selection and the processor is configured to determine the election influence based on the political party selection, the candidate selection and the pledge amount.

14. The system of claim 11, wherein the user information comprises at least one of: a name, an address, a phone number, social security information and an email address.

15. The system of claim 11, wherein the processor is configured to determine a weighted vote amount associated with an election and based on the pledge amount and the candidate selection.

16. The system of claim 11, wherein the interface is configured to transmit at least one election for political office to a user and receive a vote associated with the at least one election.

17. The system of claim 11, wherein the processor is configured to determine the election influence by comparing the pledge amount to statistical fundraising information associated with an election result.

18. The system of claim 11, wherein the interface is configured to receive a plurality of pledge amounts, and the processor is configured to determine the election influence by comparing the pledge amount to at least one of the plurality of pledge amounts.

19. The system of claim 11, wherein the processor is configured to aggregate information based on at least one of: the user information, the candidate selection and the pledge amount and the interface is configured to transmit statistical information based on the aggregated information to a computer system associated with a political party.

20. A non-transitory computer readable medium for providing a fundraising service, having stored thereon sequences of instruction that are capable of causing at least one processor to:
receive user information;
receive a candidate selection;
receive a pledge amount;
store the user information, the candidate selection and the pledge amount; and
determine an election influence associated with the candidate selection and the pledge amount.

21. The non-transitory computer readable medium of claim 20, further comprising instructions that are capable of causing the at least one processor to transmit the election influence to a user, and transmit the pledge amount and the user information to a computer system related to a political party.
